(19) United States
(12) Patent Application Publication
(10) Pub. No.: US 2026/0119750 A1
(43) Pub. Date: Apr. 30, 2026

(54) DISTRIBUTED SIMULATION SYSTEM AND METHOD FOR AUTONOMOUS FLIGHT SIMULATION FOR AIR MOBILITY, AND METHOD OF PROVIDING DISTRIBUTED SIMULATION PLATFORM

(71) Applicant: ELECTRONICS AND TELECOMMUNICATIONS RESEARCH INSTITUTE, Daejeon (KR)

(72) Inventors: Ui Hwan CHOI, Daejeon (KR); Jeong Gi YANG, Daejeon (KR); Soo Jeon LEE, Daejeon (KR)

(21) Appl. No.: 19/003,442

(22) Filed: Dec. 27, 2024

(30) Foreign Application Priority Data
Dec. 28, 2023 (KR) 10-2023-0195291

(51) Int. Cl. G06F 30/27; G06F 111/02

(52) U.S. Cl. CPC G06F 30/27; G06F 2111/02

(57) ABSTRACT

A distributed simulation system including a server and a plurality of clients may comprise: a plurality of first clients configured to electronically communicate with the server in a wired or wireless manner and perform modeling and autonomous flight simulation on individual aircraft; a second client configured to electronically communicate with the server in a wired or wireless manner and perform simulation of communication, navigation, or surveillance infrastructure (CNS infra) for aviation; and a third client configured to electronically communicate with the server in a wired or wireless manner and perform simulation of ground control and air traffic management.

### CROSS-REFERENCE TO RELATED APPLICATION

This application claims priority to Korean Patent Application No. 10-2023-0195291, filed on December 28, 2023, with the Korean Intellectual Property Office (KIPO), the entire contents of which are hereby incorporated by reference.

### BACKGROUND

### 1. Technical Field

Example embodiments of the present disclosure relate to a distributed open simulation technology with scalability for the development process of high-density autonomous flight technology for an urban air mobility (UAM).

### 2. Related Art

The following descriptions merely provide background information relevant to present embodiments rather than constituting the related art.

Conventionally, functions of constituent equipment that are dependent on a system design have been adapted to suit aviation the purpose of an aviation simulation to develop functions required by aviation simulation models. Therefore, after an aircraft design is confirmed, actual development of simulation models begin.

In addition, when developing simulation models required for other aircraft development projects, it is required to consider specifications, such as a real-time simulation environment of aviation-mounted equipment, a simulation engine, and the like, and develop a new model dependent on the specifications.

Meanwhile, regarding these aviation simulation methods, an integrated test system for flight simulation and testing and a method thereof have been proposed, but it is limited to presenting an avionics integration test involving a specific part of an aircraft such as the cockpit environment and other parts, and the related art only considers specifications such as a real-time simulation environment of aviation-mounted equipment and a simulation engine, and develops a new model dependent on the specifications.

When developing an aviation system, it is required to minimize the period of time from confirmation of an aircraft design to an aviation system integration level (SIL), and the time required for simulation model development, modification, and verification in order to appropriately respond to changes in interfaces and operating concepts that frequently occur during the development period.

Conventionally, there is a limitation that aviation simulation models are developed without considering portability from the early stage, which makes it difficult to reuse the simulation model in other systems.

### SUMMARY

Accordingly, example embodiments of the present disclosure are provided to substantially obviate one or more problems due to limitations and disadvantages of the related art, and provide a distributed simulation structure that enables highly scalable and highly precise simulation of tens to hundreds of future autonomous urban air mobility (UAM) aircraft.

Example embodiments of the present disclosure provide a distributed simulation structure for the interaction of autonomous UAM aircraft in a highly dense corridor and the development of technology to respond to various abnormal situations during a UAM operation.

Example embodiments of the present disclosure provide a distributed simulation structure, thereby enabling efficient and accurate simulation of various scenarios and emergency situations, prior to commercialization of actual urban air traffic systems.

Example embodiments of the present disclosure enable precise simulation of high-density autonomous flight operation scenarios that are expected in the medium to long term.

According to a first exemplary embodiment of the present disclosure, a distributed simulation system including a server and a plurality of clients may comprise: a plurality of first clients configured to electronically communicate with the server in a wired or wireless manner and perform modeling and autonomous flight simulation on individual aircraft; a second client configured to electronically communicate with the server in a wired or wireless manner and perform simulation of communication, navigation, and/or surveillance infrastructure (CNS infra) for aviation; and a third client configured to electronically communicate with the server in a wired or wireless manner and perform simulation of ground control and air traffic management.

Each of the plurality of first clients may include: an aircraft model including modeling of flight dynamics, aerodynamics, and navigation/positioning on the individual aircraft; an onboard sensor model including modeling of a sensor that obtains sensing information including visual information through at least one modality; a first artificial intelligence (AI) model including situational awareness modeling of the individual aircraft; and a second AI model including autonomous flight modeling on the individual aircraft;

The first AI model may perform modeling based on image processing, object recognition, and recognition of a Vertiport during takeoff and landing of the individual aircraft.

The second AI model may perform modeling on path generation, collision avoidance, and autonomous takeoff and landing of the individual aircraft.

The onboard sensor model may perform modeling based on a radar sensor, an electro-optical/infrared (EO/IR) sensor, and a light detection and ranging (LiDAR) sensor that are mountable on the individual aircraft.

The server may provide a communication interface for exchanging data between the plurality of first clients, the second client, and the third client, and the plurality of first clients may perform simulation of vehicle-to-vehicle (V2V) communication between the individual aircraft via the communication interface.

The server may provide a communication interface for exchanging data between the plurality of first clients, the second client, and the third client, and the third client may perform simulation of ground control and air traffic management on a plurality of aircraft modeled by the plurality of first clients based on information about the modeling and simulation provided by the plurality of first clients via the communication interface.

According to a second exemplary embodiment of the present disclosure, a distributed simulation method using a network including a server and a plurality of clients may comprise: performing, by a plurality of first clients configured to electronically communicate with the server in a wired or wireless manner, modeling and autonomous flight simulation on individual aircraft; performing, by a second client configured to electronically communicate with the server in a wired or wireless manner, simulation of communication, navigation, and/or surveillance infrastructure (CNS infra) for aviation; and performing, by a third client configured to electronically communicate with the server in a wired or wireless manner, simulation of ground control and air traffic management.

The performing, by the plurality of first clients, of modeling and autonomous flight simulation on individual aircraft may include: performing modeling of flight dynamics, aerodynamics, and navigation/positioning on the individual aircraft; performing modeling on a sensor that obtains sensing information including visual information through at least one modality using an onboard sensor model; performing situational awareness modeling on the individual aircraft using a first artificial intelligence (AI) model; and performing autonomous flight modeling on the individual aircraft using a second AI model.

The performing of the situational awareness modeling on the individual aircraft using the first AI model may include: performing modeling based on image processing, object recognition, and recognition of a Vertiport during takeoff and landing of the individual aircraft using the first AI model.

The performing of the autonomous flight modeling on the individual aircraft using the second AI model may include: performing modeling on path generation, collision avoidance, and autonomous takeoff and landing of the individual aircraft using the second AI model.

The performing of the modeling of the sensor using the onboard sensor model may include: performing modeling based on a radar sensor, an electro-optical/infrared (EO/IR) sensor, and a light detection and ranging (LiDAR) sensor that are mountable on the individual aircraft.

The distributed simulation method may further comprise: providing, by the server, a communication interface for exchanging data between the plurality of first clients, the second client, and the third client; and performing, by the plurality of first clients, simulation of vehicle-to-vehicle (V2V) communication between the individual aircraft via the communication interface.

The distributed simulation method may further comprise: providing, by the server, a communication interface for exchanging data between the plurality of first clients, the second client, and the third client; and performing, by the third client, simulation of ground control and air traffic management on a plurality of aircraft modeled by the plurality of first clients based on information about the modeling and simulation provided by the plurality of first clients via the communication interface.

According to a third exemplary embodiment of the present disclosure, a method of providing a distributed simulation platform using a network including a server and a plurality of clients may comprise: assigning a first client to each individual aircraft; accessing the server from a remote location using a web-based platform to simulate a scenario for a plurality of aircraft; and accessing, by each of the plurality of clients, the web-based platform and then exchanging information about the simulation of the plurality of aircraft with another client accessing the web-based platform based on a source code or a model held by a user.

The first client assigned to each of the individual aircraft may include an aircraft model, a flight dynamics model, and an aerodynamic model for the individual aircraft, and at least one of the aircraft model, the flight dynamics model, and/or the aerodynamic model may be changed to a new model based on a change of specifications or a shape of the individual aircraft.

The method may further comprise: assigning one or more clients to each participant participating in development of the individual aircraft.

The method may further comprise: distributing an open application programming interface (API)/interface to the server and the plurality of clients using a data distribution service (DDS).

The method may further comprise, in response to an individual aircraft being added, assigning a new first client to the added individual aircraft.

An embodiment of the present disclosure can implement a distributed open simulation structure for testing high-density autonomous flight operation scenarios of multiple UAM aircraft.

An embodiment of the present disclosure can provide a distributed simulation structure for autonomous flight in a highly dense corridor according to an embodiment of the present disclosure capable of providing the ability to precisely model a complex urban air traffic system in real time, and greatly contributing to commercialization of UAMs in the future, especially introduction of high-density autonomous flight operation scenarios.

An embodiment of the present disclosure can support the development and verification of an onboard AI technology capable of responding to various emergency situations (non-cooperative intrusion aircraft collision avoidance, simultaneous autonomous emergency landing of multiple aircraft, and the like) that can occur during high-density autonomous navigation.

### BRIEF DESCRIPTION OF DRAWINGS

FIG. 1 is a conceptual diagram illustrating the structure of a distributed urban air mobility (UAM) simulator according to an embodiment of the present disclosure.

FIG. 2 is a conceptual diagram illustrating models included in a client that performs modeling and simulation on an individual aircraft according to an embodiment of the present disclosure.

FIG. 3 is a flowchart showing a method of providing a distributed simulation platform according to an embodiment of the present disclosure.

FIG. 4 is a conceptual diagram illustrating an example of a computing system that may function as a generalized simulation apparatus, a server, or a client that may perform at least some of the processes described with reference to FIGS. 1 to 3.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even a technology known before the filing date of the present application may be included as a part of the configuration of the present disclosure when necessary, and will be described herein without obscuring the spirit of the present disclosure. However, in describing the configuration of the present disclosure, the detailed description of a technology known before the filing date of the present application that those of ordinary skill in the art can clearly understand may obscure the spirit of the present disclosure, and thus a detailed description of the related art will be omitted.

For example, as technologies for simulating a dynamics model or a control function for aviation simulation, technologies known before the application of the present disclosure may be used, and at least some of the known technologies may be used as element technologies for implementing the present disclosure. For example, by notifying that the element technology required to implement a part of the configuration of the present disclosure is known to those skilled in the art through Korean Patent Publication No. 10-1976542 “Method and system for controlling simulation via aviation simulation model,” etc., the notification may substitute for the description of the part of the configuration of the present disclosure.

However, the purpose of the present disclosure is not to claim rights to these known technologies, and the content of the known technologies may be included as part of the present disclosure within the scope not departing from the spirit of the present disclosure.

Hereinafter, exemplary embodiments of the present disclosure will be described in more detail with reference to the accompanying drawings. In order to facilitate overall understanding when describing the present disclosure, the same reference numerals are used for the same elements in the drawings, and overlapping descriptions of the same elements are omitted.

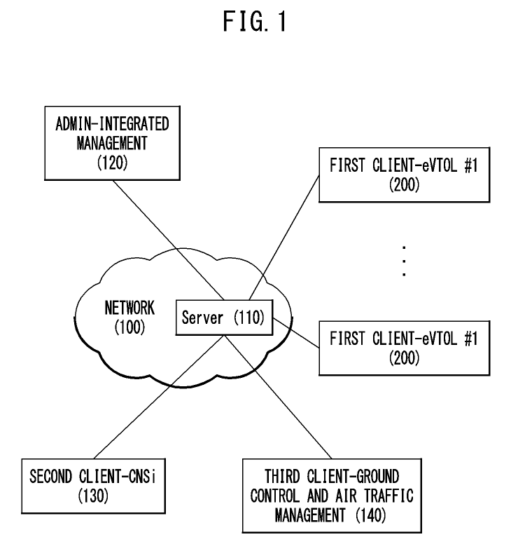

FIG. 1 is a conceptual diagram illustrating the structure of a distributed urban air mobility (UAM) simulator according to an embodiment of the present disclosure.

The present disclosure relates to a simulation system and method used in the development process of an autonomous flight technology in a highly dense corridor, which is required in the mid to long term for commercialization of a UAM.

The present disclosure includes a distributed open-simulation technology with scalability for precisely simulating a scenario in which multiple UAM aircraft equipped with an autonomous flight AI safely and efficiently operate autonomously even in a highly dense corridor of urban and regional airspaces.

For commercialization of UAMs, it is required to ensure cost-effectiveness as well as safety, and for this, it is required to ensure fully autonomous flight and high-density operation technology for multiple UAM aircraft within a corridor in the mid to long term. Accordingly, it is imperative to establish scenarios for various abnormal operations and contingencies that may occur during high-density/autonomous flight operation within a corridor, and to develop corresponding response technologies for each scenario. To this end, there is a need to develop a dedicated simulator for verifying scenarios of high-density/autonomous flight in an urban operation environment.

Situations in which the operating environment is not normal (off-nominal) are classified in detail as minor abnormal operations, contingencies, and emergencies. Minor abnormal operations may include communication network connection errors, sudden appearance of a non-cooperative aircraft within a corridor, or unexpected adverse weather conditions on the flight path. In the event of a communication network connection error, control may be made to switch to an alternative communication method and continue a normal operation. In the event of a sudden appearance of a non-cooperative aircraft within a corridor, control may be made to implement tactical collision avoidance and then continue a normal operation. In the event of an unexpected adverse weather condition on the flight path, control may be made to change the flight path and continue a normal operation.

Contingencies may include malfunctions of aircraft components after a bird strike. In this case, the aircraft may be guided to make an emergency landing. Contingencies may include cases in which an alternative flight route may not be designated in the event of an unexpected adverse weather condition on the flight path. Even in this case, the aircraft may be guided to make an emergency landing.

Even with single aircraft, UAM simulators consume significant computational resources. A large amount of computation is required to model and simulate various detailed modules, for aerodynamics, dynamics, avionics, 5G/6G communication, urban digital twins, and onboard sensors with high precision. In particular, for the development and verification of AI-based UAM autonomous flight technology that needs be secured in the mid to long term, UAM simulators are required to support AI computation functions to run various advanced AI modules.

Precise simulation of future high-density operation environments, in which tens of high-computational autonomous UAM aircraft are expected only within a single corridor, is challenging to perform within a specific PC, a specific server or resource, or a specific workstation. Therefore, for precise simulation of a high-density, autonomous UAM scenario that may occur in the future, a new concept of simulator or platform structure with sufficient scalability in the number of UAM aircraft is required.

When there is a high-density traffic of tens of vehicles in a corridor, the number of possible off-nominal situations may exponentially increase, and in this case, it may be very difficult to establish a response manual for each case and define the requirements for onboard autonomous flight AIs to respond to emergency situations.

Depending on the characteristics of external factors that cause an abnormal situation, the same abnormal situation may simultaneously occur in a plurality of aircraft. For example, errors in ground 5G/6G base stations in a specific area may cause communication errors for all aircraft within a specific local airspace, and unexpected adverse weather conditions may cause a specific airspace to be defined as a temporary no-fly zone.

There is also a possibility that different types of abnormal situations may occur simultaneously in a plurality of aircraft. For example, even when a traffic abnormality occurs in only one aircraft, it may affect flight plans of other aircraft that are in normal operation. Thus, the impact of an abnormal situation on a single aircraft may propagate to other aircraft, potentially leading to modifications in flight plans or emergency landings for a plurality of aircraft. Since empirical testing for such a sudden situation incurs significant costs, it is required to configure and analyze a large number of various test scenario sets through precise simulation in advance.

Conventional simulators that rely on a single specific computational workstation show significant limitations in scalability in the number of aircraft when implementing a high-density autonomous flight scenario that requires testing of AIs of multiple onboard aircraft flying simultaneously (fidelity vs. scalability trade-off). By using a server-client structure, in which only minimum required data (telemetry (TM), tele-command (TC), vehicle-to-vehicle (V2V) communication, control/traffic volume information, and the like) between each aircraft is exchanged through a server, and other aircraft-dependent high calculation modules (an aircraft physical model, an autonomous flight AI, and the like) may be distributed between individual client PCs, it is possible to provide a simulator capable of resolving the limitations of the conventional technology and responding to scalability for a large number of aircraft while maintaining high precision.

The present disclosure includes a central server 110 and a plurality of client systems. The central server 110 performs network communication and data coordination, and at least one first client 200 performs distributed processing on high-computation tasks, such as modeling of various UAM aircraft, such as an electric vertical takeoff and landing (eVTOL) aircraft, high-precision autonomous flight algorithms, and sensor data processing, In this case, a single first client is dedicated to a single aircraft, thereby reducing the computational load of the entire simulation system of the aircraft.

The clients 130 and 140 may include different simulation modules, which may be executed independently in an integrated simulation environment.

The server 110 provides a communication interface required for exchanging the minimum required data between clients, through which V2V communication and control and traffic information exchange between eVTOL aircraft is achieved. In addition, through an open application programming interface (API), various stakeholders and participants may freely access the simulation platform, test self-developed simulation modules, and share the results.

More specifically, the present disclosure includes the following embodiments.

A central server 110 may be a key component responsible for coordinating and managing data between all clients.

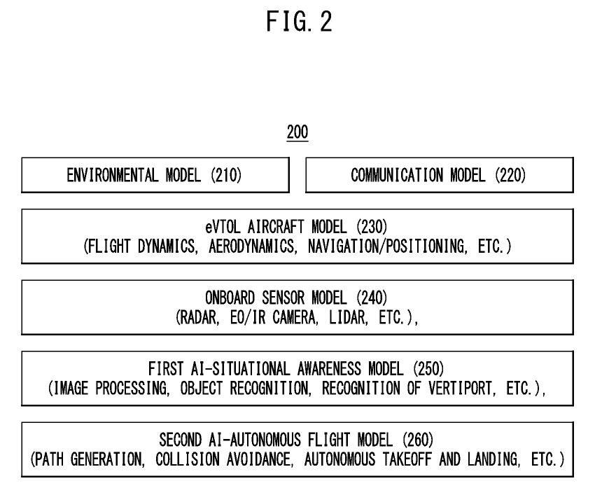

A first client 200 for simulating a UAM aircraft (an eVTOL aircraft) may be an independent task unit that models each eVTOL aircraft and runs an autonomous flight algorithm. As will be described below in FIG. 2, the first client 200 may include detailed modules, including an environmental model 210, an aircraft model 230 (flight dynamics, aerodynamics, navigation/positioning, etc.), an onboard sensor model 240 (a radar, an electro-optical/infrared (EO/IR) sensor, a light detection and ranging (LiDAR) sensor, etc.), a situational awareness AI model 250 (image processing, object recognition, recognition of a Vertiport during takeoff and landing), and an autonomous flight AI model 260 (path generation, collision avoidance, autonomous takeoff and landing, etc.).

A Client-CNS infrastructure (CNSi) client 130 may simulate communication, navigation, and/or surveillance infrastructure.

An air traffic/integrated traffic control client 140 may include a simulation module that manages and controls ground and air traffic flows.

An administrator client 120 may provide an interface for setting and managing the entire simulation scenario.

Other clients, such as a Vertiport client, a UAM rider (a customer) client, a UAM service provider client, a weather information generation/observation client, etc. may be further included.

A distributed simulation system according to an embodiment of the present disclosure may include: a plurality of first clients 200 configured to electronically communicate with the server 110 via a wired or wireless network 100, and perform modeling and autonomous flight simulation on individual aircraft; a second client 130 configured to electronically communicate with the server 110 via the wired or wireless network 100, and perform simulation of CNSi for aviation; and a third client 140 configured to electronically communicate with the server 110 via the wired or wireless network 100, and perform simulation of ground control and air traffic management.

The server 110 may provide a communication interface capable of exchanging data between the plurality of first clients 200, the second client 130, and the third client 140.

The plurality of first clients 200 may perform a simulation of V2V communication between individual aircraft via the communication interface.

The third client 140 may perform simulation of ground control and air traffic management on a plurality of aircraft modeled by the plurality of first clients 200 based on information about the modeling and simulation provided by the plurality of first clients 200 via the communication interface.

The distributed simulation system according to the embodiment of the present disclosure may further include an admin-integrated management client 120 that may manage the entire simulation system.

FIG. 2 is a conceptual diagram illustrating models included in a client that performs modeling and simulation on an individual aircraft according to an embodiment of the present disclosure.

Each of the plurality of first clients 200 may include: an eVTOL aircraft model 230 including modeling of flight dynamics, aerodynamics, and navigation/positioning on the individual aircraft; an onboard sensor model 240 including modeling of a sensor that obtains sensing information (a radar, a LiDAR, an EO/IR sensor, and the like) including visual information through at least one modality; a first AI model 250 including situational awareness modeling of the individual aircraft; and a second AI model 260 including autonomous flight modeling on the individual aircraft.

The first AI model 250 may perform modeling based on image processing, object recognition, and recognition of a Vertiport during takeoff and landing of the individual aircraft.

The second AI model 250 may perform modeling for path generation, collision avoidance, and autonomous takeoff and landing of the individual aircraft.

The onboard sensor model 240 may perform modeling based on a radar sensor, an EO/IR sensor, and a LiDAR sensor that are mountable on the individual aircraft.

Each of the plurality of first clients 200 may further include an environmental model 210 that models an environment in which the individual aircraft may operate, and a communication model 220 that models communications involved with the individual aircraft.

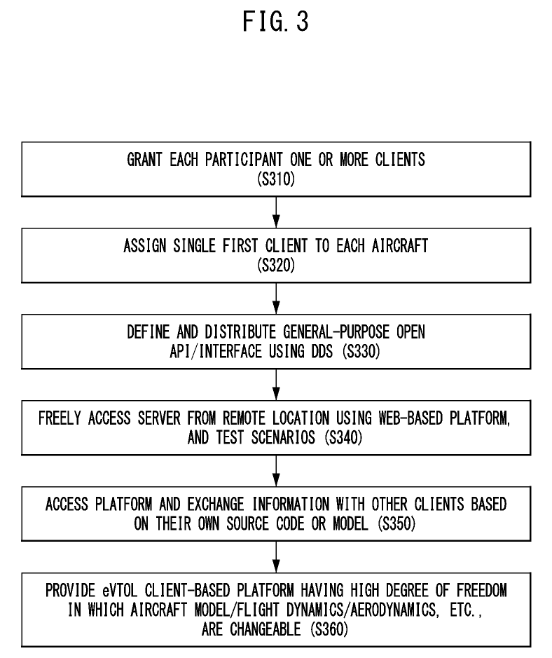

FIG. 3 is a flowchart showing a method of providing a distributed simulation platform according to an embodiment of the present disclosure.

The UAM market is in the early stages of development in which a related ecosystem is being generated, and many different institutional/private/public stakeholders are expressing an intention to participate in the UAM market. Considering this, the distributed simulator structure may be implemented as an open platform including the following parts.

One or more independent clients may be granted or assigned to each stakeholder/participant since the UAM sector has a large number of stakeholders from various fields and many development companies/institutions are involved (S310).

A single dedicated PC/client may be assigned to each aircraft (S320).

A general-purpose open API/interface may be defined and distributed using a data distribution service (DDS) or the like (S330).

The open distributed simulation platform may be built using a web-based platform, allowing various stakeholders to freely access the server even from a remote location and test scenarios (S340).

Each stakeholder/participant may access the platform and exchange information with other clients without distributing their own source code or modeling to the other clients (S350). The stakeholder/participants may be considered to be included in the concept of 'user' in this specification.

A client-based platform, which is designed to allow aircraft development companies to change an aircraft model/flight dynamics/aerodynamics, etc., by reflecting an eVTOL aircraft shape having a high degree of freedom, may be provided (S360).

According to an embodiment of the present disclosure, a method of providing a distributed simulation platform using a network including a server and a plurality of clients may include: assigning a dedicated first client to each individual aircraft (S320); accessing the server from a remote location using a web-based platform to simulate a scenario for a plurality of aircraft (S340); and accessing, by each of the plurality of clients, the web-based platform and exchanging information about the simulation of the plurality of aircraft with another client accessing the web-based platform based on a source code or a model held by the user (S350).

The first client assigned to each of the individual aircraft may include an aircraft model, a flight dynamics model, and an aerodynamic model for the individual aircraft.

At least one of the aircraft model, the flight dynamics model, and/or the aerodynamic model may be changed to a new model based on a change of specifications or a shape of the individual aircraft.

The method of providing a distributed simulation platform according to the embodiment of the present disclosure may further include assigning one or more clients to each participant participating in development of the individual aircraft.

The method of providing a distributed simulation platform according to the embodiment of the present disclosure may further include distributing an open API/interface to the server and the plurality of clients using a DDS (S330).

The method of providing a distributed simulation platform according to the embodiment of the present disclosure may further include, in response to an individual aircraft being added, assigning a new first client to the added individual aircraft.

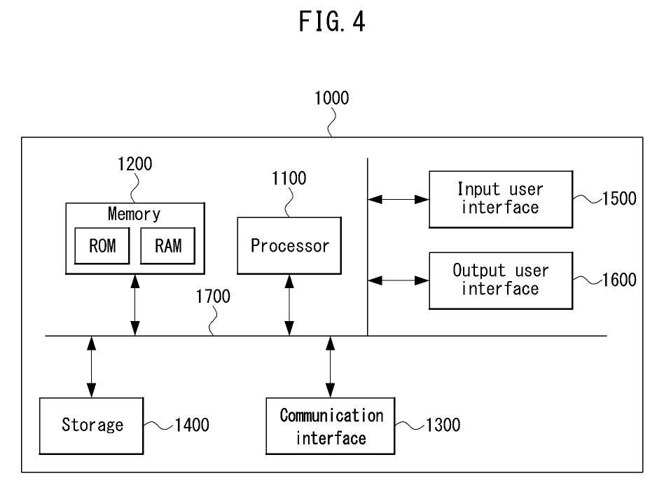

FIG. 4 is a conceptual diagram illustrating an example of a computing system that may function as a generalized simulation apparatus, a server, or a client that may perform at least some of the processes described with reference to FIGS. 1 to 3.

For example, the server 110 and each client 120, 130, 140, and 200 shown in FIG. 1 may be implemented as the computing system shown in FIG. 4.

At least some processes of the simulation, the distributed simulation, the method of providing a distributed simulation platform, or the method of managing a simulator according to the embodiment of the present disclosure may be executed by the computing system 1000 shown in FIG. 4.

Referring to FIG. 4, the computing system 1000 according to the embodiment of the present disclosure may include a processor 1100, a memory 1200, a communication interface 1300, a storage device 1400, an input interface 1500, an output interface 1600, and a bus 1700.

The computing system 1000 according to the embodiment of the present disclosure may include at least one processor 1100 and a memory 1200 that stores instructions instructing the at least one processor 1100 to perform at least one operation. At least some operations of the method according to an embodiment of the present disclosure may be performed by the at least one processor 1100 loading instructions from the memory 1200 and executing the loaded instructions.

The processor 1100 may be a central processing unit (CPU), a graphics processing unit (GPU), or a dedicated processor by which methods according to embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random-access memory (RAM).

Additionally, the computing system 1000 may include a communication interface 1300 that performs communication through a wireless network.

Additionally, the computing system 1000 may further include a storage device 1400, an input interface 1500, an output interface 1600, and the like.

Additionally, the components included in the computing system 1000 may be connected by a bus 1700 to communicate with each other.

Examples of the computing system 1000 according to the present disclosure may include a desktop computer, a laptop computer, a notebook computer, a smart phone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, a personal digital assistant (PDA), and the like that are capable of communication.

A distributed simulation method according to an embodiment of the present disclosure may be a distributed simulation method using a network including a server and a plurality of clients, and include: performing, by a plurality of first clients configured to electronically communicate with the server in a wired or wireless manner, modeling and autonomous flight simulation on individual aircraft; performing, by a second client configured to electronically communicate with the server in a wired or wireless manner, simulation of CNSi for aviation; and performing, by a third client configured to electronically communicate with the server in a wired or wireless manner, simulation of ground control and air traffic management.

The performing, by the plurality of first clients, of modeling and autonomous flight simulation on individual aircraft may include: performing modeling of flight dynamics, aerodynamics, and navigation/positioning on the individual aircraft; performing modeling on a sensor that obtains sensing information including visual information through at least one modality using an onboard sensor model; performing situational awareness modeling on the individual aircraft using a first artificial intelligence (AI) model; and performing autonomous flight modeling on the individual aircraft using a second AI model.

The performing of the situational awareness modeling on the individual aircraft using the first AI model may include performing modeling based on image processing, object recognition, and recognition of a Vertiport during takeoff and landing of the individual aircraft using the first AI model.

The performing of the autonomous flight modeling on the individual aircraft using the second AI model may include performing modeling on path generation, collision avoidance, and autonomous takeoff and landing of the individual aircraft using the second AI model.

The performing of the modeling of the sensor using the onboard sensor model may include performing modeling based on a radar sensor, an electro-optical/infrared (EO/IR) sensor, and a LiDAR sensor that are mountable on the individual aircraft.

The distributed simulation method according to an embodiment of the present disclosure may further include: providing, by the server, a communication interface for exchanging data between the plurality of first clients, the second client, and the third client; and performing, by the plurality of first clients, simulation of V2V communication between the individual aircraft via the communication interface.

The distributed simulation method according to an embodiment of the present disclosure may further include: providing, by the server, a communication interface for exchanging data between the plurality of first clients, the second client, and the third client; and performing, by the third client, simulation of ground control and air traffic management on a plurality of aircraft modeled by the plurality of first clients based on information about the modeling and simulation provided by the plurality of first clients via the communication interface.

As is apparent from the above, an embodiment of the present disclosure can implement a distributed open simulation structure for testing high-density autonomous flight operation scenarios of multiple UAM aircraft.

An embodiment of the present disclosure can provide a distributed simulation structure for autonomous flight in a highly dense corridor according to an embodiment of the present disclosure capable of providing the ability to precisely model a complex urban air traffic system in real time, and greatly contributing to commercialization of UAMs in the future, especially introduction of high-density autonomous flight operation scenarios.

An embodiment of the present disclosure can support the development and verification of an onboard AI technology capable of responding to various emergency situations (non-cooperative intrusion aircraft collision avoidance, simultaneous autonomous emergency landing of multiple aircraft, and the like) that can occur during high-density autonomous navigation.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A distributed simulation system including a server and a plurality of clients, comprising:
a plurality of first clients configured to electronically communicate with the server in a wired or wireless manner and perform modeling and autonomous flight simulation on individual aircraft;
a second client configured to electronically communicate with the server in a wired or wireless manner and perform simulation of communication, navigation, or surveillance infrastructure (CNS infra) for aviation; and
a third client configured to electronically communicate with the server in a wired or wireless manner and perform simulation of ground control and air traffic management.

2. The distributed simulation system of claim 1, wherein each of the plurality of first clients includes:
an aircraft model including modeling of flight dynamics, aerodynamics, and navigation/positioning on the individual aircraft;
an onboard sensor model including modeling of a sensor that obtains sensing information including visual information through at least one modality;
a first artificial intelligence (AI) model including situational awareness modeling of the individual aircraft; and
a second AI model including autonomous flight modeling on the individual aircraft.

3. The distributed simulation system of claim 2, wherein the first AI model performs modeling based on image processing, object recognition, and recognition of a Vertiport during takeoff and landing of the individual aircraft.

4. The distributed simulation system of claim 2, wherein the second AI model performs modeling on path generation, collision avoidance, and autonomous takeoff and landing of the individual aircraft.

5. The distributed simulation system of claim 2, wherein the onboard sensor model performs modeling based on a radar sensor, an electro-optical/infrared (EO/IR) sensor, and a light detection and ranging (LiDAR) sensor that are mountable on the individual aircraft.

6. The distributed simulation system of claim 1, wherein the server provides a communication interface for exchanging data between the plurality of first clients, the second client, and the third client, and
the plurality of first clients perform simulation of vehicle-to-vehicle (V2V) communication between the individual aircraft via the communication interface.

7. The distributed simulation system of claim 1, wherein the server provides a communication interface for exchanging data between the plurality of first clients, the second client, and the third client, and
the third client performs simulation of ground control and air traffic management on a plurality of aircraft modeled by the plurality of first clients based on information about the modeling and simulation provided by the plurality of first clients via the communication interface.

8. A distributed simulation method using a network including a server and a plurality of clients, the method comprising:
performing, by a plurality of first clients configured to electronically communicate with the server in a wired or wireless manner, modeling and autonomous flight simulation on individual aircraft;
performing, by a second client configured to electronically communicate with the server in a wired or wireless manner, simulation of communication, navigation, or surveillance infrastructure (CNS infra) for aviation; and
performing, by a third client configured to electronically communicate with the server in a wired or wireless manner, simulation of ground control and air traffic management.

9. The distributed simulation method of claim 8, wherein the performing, by the plurality of first clients, of modeling and autonomous flight simulation on individual aircraft includes:
performing modeling of flight dynamics, aerodynamics, and navigation/positioning on the individual aircraft;
performing modeling on a sensor that obtains sensing information including visual information through at least one modality using an onboard sensor model;
performing situational awareness modeling on the individual aircraft using a first artificial intelligence (AI) model; and
performing autonomous flight modeling on the individual aircraft using a second AI model.

10. The distributed simulation method of claim 9, wherein the performing of the situational awareness modeling on the individual aircraft using the first AI model includes performing modeling based on image processing, object recognition, and recognition of a Vertiport during takeoff and landing of the individual aircraft using the first AI model.

11. The distributed simulation method of claim 9, wherein the performing of the autonomous flight modeling on the individual aircraft using the second AI model includes performing modeling on path generation, collision avoidance, and autonomous takeoff and landing of the individual aircraft using the second AI model.

12. The distributed simulation method of claim 9, wherein the performing of the modeling of the sensor using the onboard sensor model includes performing modeling based on a radar sensor, an electro-optical/infrared (EO/IR) sensor, and a light detection and ranging (LiDAR) sensor that are mountable on the individual aircraft.

13. The distributed simulation method of claim 8, further comprising:
providing, by the server, a communication interface for exchanging data between the plurality of first clients, the second client, and the third client; and
performing, by the plurality of first clients, simulation of vehicle-to-vehicle (V2V) communication between the individual aircraft via the communication interface.

14. The distributed simulation method of claim 8, further comprising:
providing, by the server, a communication interface for exchanging data between the plurality of first clients, the second client, and the third client; and
performing, by the third client, simulation of ground control and air traffic management on a plurality of aircraft modeled by the plurality of first clients based on information about the modeling and simulation provided by the plurality of first clients via the communication interface.

15. A method of providing a distributed simulation platform using a network including a server and a plurality of clients, the method comprising:
assigning a first client to each individual aircraft;
accessing the server from a remote location using a web-based platform to simulate a scenario for a plurality of aircraft; and
accessing, by each of the plurality of clients, the web-based platform and then exchanging information about the simulation of the plurality of aircraft with another client accessing the web-based platform based on a source code or a model held by a user.

16. The method of claim 15, wherein the first client assigned to each of the individual aircraft includes an aircraft model, a flight dynamics model, and an aerodynamic model for the individual aircraft, and
at least one of the aircraft model, the flight dynamics model, or the aerodynamic model is changed to a new model based on a change of specifications or a shape of the individual aircraft.

17. The method of claim 15, further comprising assigning one or more clients to each participant participating in development of the individual aircraft.

18. The method of claim 15, further comprising distributing an open application programming interface (API)/interface to the server and the plurality of clients using a data distribution service (DDS).

19. The method of claim 15, further comprising, in response to an individual aircraft being added, assigning a new first client to the added individual aircraft.
